(19) United States
(12) Patent Application Publication
(10) Pub. No.: US 2024/0253971 A1
(43) Pub. Date: Aug. 1, 2024

(54) DISPENSING DEVICE FOR DISPENSING A BEVERAGE/SLUSH AND METHOD FOR DISPENSING THEREOF

(71) Applicant: ELMECO S.R.L., CASANDRINO (IT)

(72) Inventor: Umberto CORTESE, CASANDRINO (IT)

(73) Assignee: ELMECO S.R.L., CASANDRINO (IT)

(21) Appl. No.: 18/429,731

(22) Filed: Feb. 1, 2024

(30) Foreign Application Priority Data
Feb. 1, 2023 (IT) 102023000001551

(51) Int. Cl. B67D 7/34; B67D 1/00; B67D 1/12

(52) U.S. Cl. CPC B67D 7/346; B67D 1/0019; B67D 1/1202

(57) ABSTRACT

A dispensing device for dispensing a beverage/slush. The dispensing device is configured to automatically dose a beverage/slush over time with respect to the capacity of a cup to be filled with said beverage/slush and to the weight of the cup which changes over time, due to the quantity of beverage/slush that is received by the cup over time with respect to a predetermined weight associated with a predetermined beverage/slush, corresponding to the beverage/slush dispensed by the dispensing device, and a predetermined capacity of a cup, corresponding to the capacity of the cup that receives said beverage/slush, where, in the predetermined beverage, the predetermined weight and the predetermined capacity are data stored in the dispensing device. Embodiments also relate to a method for dispensing through the dispensing device.

### FIELD

The present invention relates to a dispensing device for dispensing a beverage/slush.

In particular, the present invention relates to the structure of said automatic dispensing system conceived so that the quantity of beverage/slush that is dispensed to fill a cup is automatically dosed over time with respect to the capacity of the cup and to the weight of the cup which changes over time, due to the quantity of beverage/slush that is received by the cup over time.

The term “capacity” means the capacity of a cup to contain a certain quantity of liquid, generally expressed in millilitres/ounces.

In the detailed description that follows, reference will be made to a dispensing device for dispensing a slush.

However, the same dispensing device can be used to dispense a beverage, without going outside the scope of the invention.

### BACKGROUND

At present, there are no known dispensing devices capable of dispensing a beverage/slush and performing an automatic dosing of the beverage while it is being dispensed.

With particular reference to a slush, dosing is not a simple operation, since the density of the slush can change over time based on different factors.

These factors can be the quantity of sugar, the temperature, how long the slush remained in the receptacle before being dispensed, the quantity of slush present in the receptacle, and the pushing force exerted by pushing means to push a quantity of slush out of said receptacle.

One disadvantage due to an incorrect dosing of a beverage/slush is that the cup can be filled too much (with the risk that the beverage/slush overflows from the cup) or too little with respect to the capacity of the cup itself.

In general, an operator manually doses a beverage with respect to the level of filling of a cup.

A dispensing device of a known type comprises a tank containing a beverage/slush and a nozzle by means of which said beverage/slush comes out of the dispensing device.

In a first example of a dispensing device of a known type, said dispensing device comprises a lever to allow the dispensing of the beverage/slush.

The lever can be manually actuated by an operator.

In particular, the lever is movable between a first position, in which the passage of the beverage/slush from the tank to the nozzle is prevented, and a second direction (opposite said first direction), in which the passage of the beverage/slush to the nozzle is enabled.

In a second example of a dispensing device of a known type, the dispensing device is provided with a pushbutton or, alternatively, a user interface (which can be digital or analogue) for selecting a quantity of beverage/slush based on the size of the cup destined to receive said quantity of beverage/slush.

### SUMMARY

The aim of the present invention is to overcome said disadvantage by providing a dispensing device for dispensing a beverage/slush configured to automatically dose the beverage/slush over time with respect to the capacity of a cup (to be filled with said beverage/slush) and to the weight of said cup which changes over time, due to the quantity of beverage/slush received by said cup, in order to prevent the cup from being filled too much, i.e. to the extent that a quantity of beverage/slush overflows from the cup itself, or too little, i.e. when the level of filling of the cup is not appropriate with respect to the quantity of beverage/slush that said cup should contain.

In particular, the aim of the present invention is to provide a dispensing device configured to automatically dose the beverage/slush over time with respect to a predetermined weight associated with a predetermined beverage/slush (corresponding to the beverage/slush dispensed by the dispensing device) and a predetermined capacity of a cup (corresponding to the capacity of the cup that receives said beverage/slush), wherein said predetermined beverage, said predetermined weight and said predetermined capacity are data stored in the dispensing device.

The object of the invention is a dispensing device for dispensing a beverage/slush comprising:
a receptacle containing a beverage/slush;
a conduit connected to said receptacle for receiving said beverage/slush and provided with an opening,
a piston movable in said conduit in a first direction and in a second direction, opposite to said first direction, so that said opening is closed or free or partially closed according to the movement of said piston in said conduit,
moving means for moving said piston in said conduit,
a supporting base for supporting said cup,
at least one code reader for reading a QR code;
at least one presence sensor for detecting the presence of a cup on said supporting base,
at least one weight sensor for detecting the weight of the cup over time during dispensing of the beverage/slush;
storage means in which the following data are stored:
   one or more predetermined beverages/slushes,
   one or more predetermined capacities of a cup,
   a predetermined weight associated with a respective beverage/slush to be dispensed into said cup and a respective predetermined capacity of said cup,
a control logic unit configured to:
   acquire, through the presence sensor, information concerning the presence of the cup on the supporting base,
   acquire, through the code reader, information contained in the code concerning the capacity of the cup,
   acquire, through said weight sensor, the weight of the cup over time during dispensing of the beverage/slush,
   send a signal to said moving means for moving said piston so that said piston approaches said opening until partially or totally covering said opening, so as to reduce the quantity of beverage/slush to be dispensed or terminate the dispensing of said beverage/slush, or that said piston moves away from said opening, so as to increase the quantity of beverage/slush to be dispensed, based on the weight of the cup acquired over time, during dispensing of the beverage/slush, with respect to a predetermined beverage/slush and to a predetermined weight associated with a predetermined capacity, wherein said predetermined beverage/slush is equal to the beverage/slush dispensed by said dispensing device and said predetermined capacity is equal to the acquired capacity.

Further preferred embodiments of the dispensing device are described in the dependent claims.

The present invention also relates to a method of dispensing by means of said dispensing device.

### BRIEF DESCRIPTION OF THE DRAWINGS

The present invention will now be described, by way of illustration and not by way of limitation, according to an embodiment thereof, with particular reference to the appended Figures, wherein:

FIG. 1 is a perspective view of the dispensing device for dispensing a slush, according to the invention;

FIG. 2 is a partly exploded perspective view of the dispensing device in FIG. 1;

FIG. 3 is a longitudinal sectional view of the dispensing device in FIG. 1;

FIG. 4 is a partly exploded view of a portion of the dispensing device in FIG. 2 comprising a receptacle containing a slush, a conduit connected to said receptacle and provided with an opening, a piston slidable in said conduit and a stepper motor for moving said piston in the conduit to allow/prevent the passage of the slush through the opening of the conduit towards a nozzle;

FIG. 5A shows a detail of the dispensing device in FIG. 3, wherein the piston closes the opening of the conduit connected to the receptacle and prevents the passage of the slush towards the nozzle;

FIG. 5B shows a detail of the dispensing device in FIG. 3, wherein the piston partly closes the opening of the conduit connected to the receptacle and allows the passage of a quantity of slush towards the nozzle;

FIG. 5C shows a detail of the dispensing device in FIG. 3, wherein the piston is in a position such as to leave the opening of the conduit free and allow the passage of a quantity of slush towards the nozzle;

FIG. 6A shows a portion of the dispensing device in FIG. 3 comprising a cup holder and a weight sensor for detecting the weight of the cup when the cup is positioned on said cup holder;

FIG. 6B shows a detail of the portion of the dispensing device in FIG. 6A;

FIG. 7 shows the dispensing device according to FIG. 1 and a cup to be filled with a slush in proximity to a code reader of the dispensing device for reading the QR code applied on the cup itself;

FIG. 8 shows the dispensing device in FIG. 7, wherein the cup has been positioned on a cup holder arranged inside a compartment of the dispensing device;

FIG. 9 shows the dispensing device of FIG. 8 in use and the cup that is being filled with slush;

FIG. 10 shows the dispensing device in FIG. 9 when the dispensing of the slush has terminated and the cup can be taken by a user;

FIG. 11 shows a variant of the dispensing device.

### DETAILED DESCRIPTION OF THE EMBODIMENTS

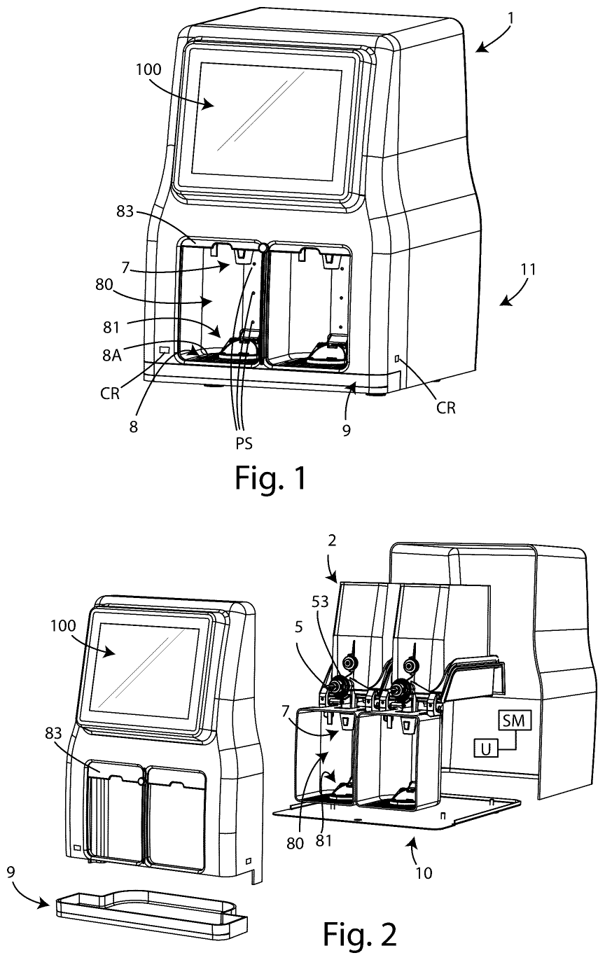

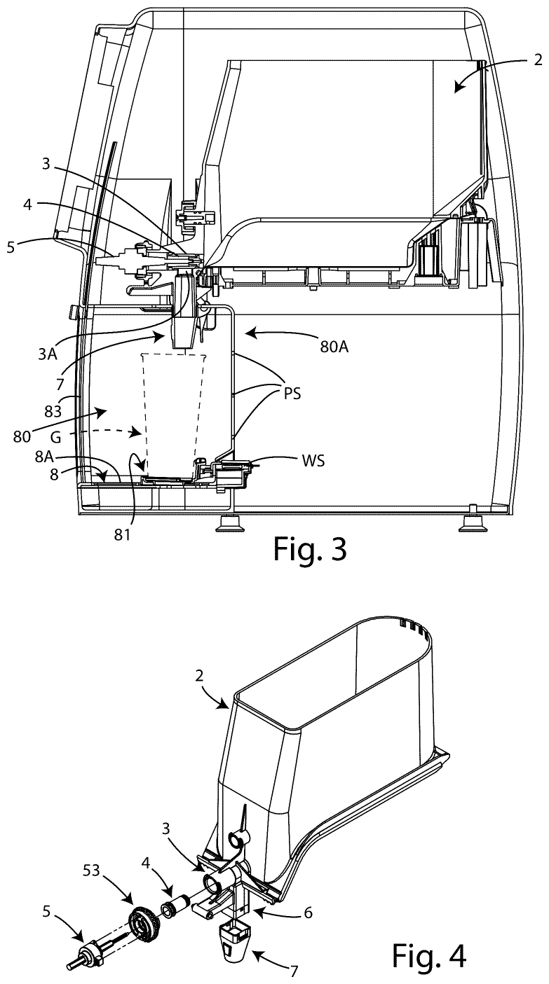

With reference to FIGS. 1 to 3, a dispensing device for dispensing a beverage/slush, indicated by the reference number 1, is described.

In the example that is described, the dispensing device 1 is a dispensing device for dispensing a slush.

In particular, said dispensing device 1 is conceived to dispense an appropriate quantity of slush into a cup G with respect to the capacity of said cup G.

With reference to the cup G, said cup G can be made of different materials.

In the example that is described, said cup G is provided with a QR code.

The QR code comprises at least one information concerning the capacity of the cup G itself.

With reference to the dispensing device 1, said dispensing device 1 comprises:
at least one receptacle or tank 2 containing a slush,
at least one conduit 3 for receiving said slush, wherein said conduit 3 is connected to said receptacle 2 and is provided with an opening 3A for the passage of a quantity of slush,
at least one piston 4 movable in said conduit 3 in a first direction and in a second direction, opposite to said first direction, so that said opening 3A is closed or free or partially closed according to the movement of said piston 4 in said conduit 3,
for each piston 4, respective moving means 5 for moving a piston 4 in a respective conduit 3.

Furthermore, the dispensing device 1 comprises at least one nozzle 7 for the outflow of said slush.

Said nozzle 7 is connected to the opening 3A of the conduit 3 by means of a further conduit 6.

In the example that is described, said further conduit 6 is perpendicular or substantially perpendicular to said conduit 3.

Said nozzle 7 allows the slush, i.e. the slush that comes out of the opening 3A of the conduit 3, to be directed inside the cup G.

In the example that is described, said nozzle 7 has a substantially truncated cone shape.

However, the nozzle 7 can have any shape whatsoever, different from the abovementioned shape, without going outside the scope of the invention.

The dispensing device 1 comprises at least one supporting base 8 for supporting said cup G.

In particular, said dispensing device 1 comprises at least one compartment 80 (described further ahead) for receiving said cup G and said supporting base 8 is part of said compartment 80.

Furthermore, the dispensing device 1 comprises a casing 11.

In the embodiment that is described, the dispensing device 1 comprises two receptacles or tanks for receiving a respective type of slush and is capable of dispensing two types of slush.

In particular, the dispensing device 1 comprises two conduits 3, wherein each conduit 3 is connected to a respective receptacle 2, two pistons, wherein each piston is movable in a respective conduit 3, and respective moving means 5 for each piston 4, as well as two compartments comprising a respective supporting base 8 for supporting a respective cup G.

The explanation of the operation of the dispensing device 1 will refer to the dispensing of a slush present in one of the two receptacles of the dispensing device 1 and thus the path of the slush from said receptacle 2 to one of the two nozzles of the dispensing device 1.

However, the same considerations apply for the dispensing of a further slush present in a further receptacle 2 of the dispensing device 1 and thus to the path of said further slush from said further receptacle 2 to a further nozzle 7 of the dispensing device 1.

With particular reference to the receptacle 2, said receptacle 2 can have any shape whatsoever.

Furthermore, the size of said receptacle 2 depends on the quantity of slush to be contained.

With particular reference to the conduit 3, the opening 3A is passed through by a first axis A1, perpendicular to the supporting base 8, and the conduit 3 extends along a second axis A2, perpendicular or substantially perpendicular to said first axis A1 (FIG. 4).

Consequently, the piston 4 moves in said first direction and in said second direction along said second axis A2.

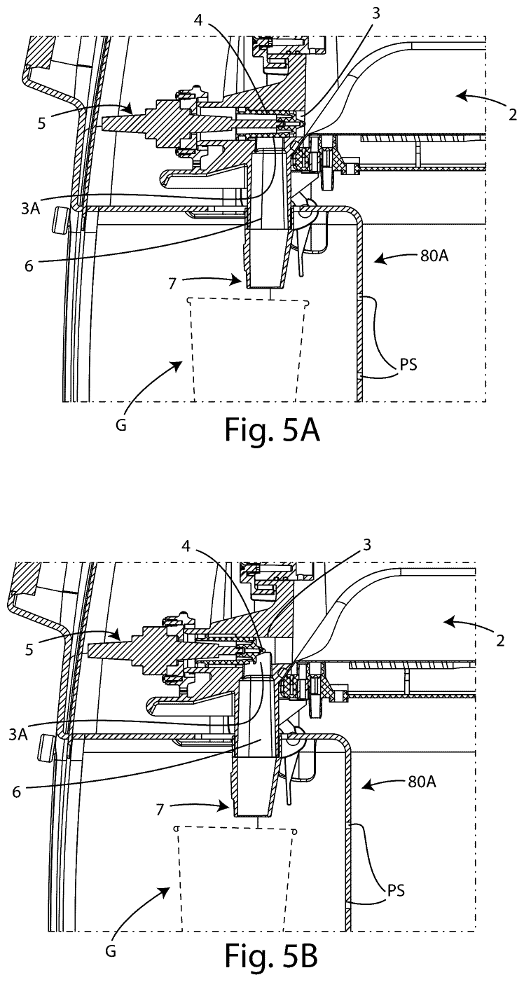

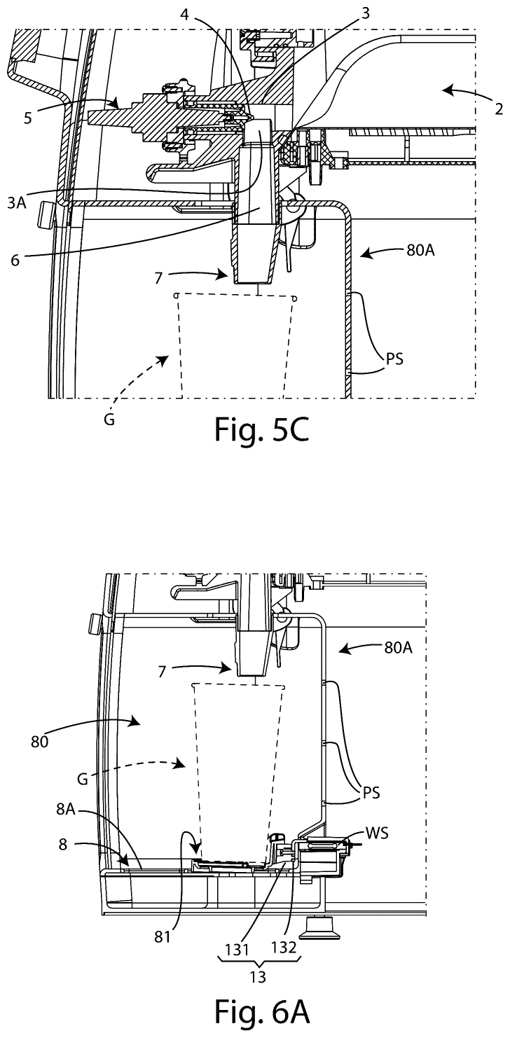

As mentioned, the movement of the piston 4 inside the conduit 3 is such as to totally close the opening 3A of the conduit 3 (FIG. 5A) or partially close the opening of the conduit 3 (FIG. 5B) or leave the opening 3A completely free (FIG. 5C), i.e. the opening 3A is not closed by the piston 4.

In the case where the opening 3A of the conduit 3 is totally closed, the passage of the slush from the receptacle or tank 2 to the opening 3A of the conduit 3 is prevented and thus the slush does not come out of the nozzle 7.

Therefore, in this case, the dispensing of the slush is not allowed.

In the case where the opening 3A of the conduit 3 is partially closed by the piston 4, a quantity of slush will come out of the nozzle 7.

In the case where the opening 3A of the conduit 3 is free, a quantity of slush will come out of the nozzle 7.

In the latter case, the quantity of slush that comes out of the nozzle 7 will be greater than the quantity of slush that comes out of the nozzle 7 in the case where the opening 3A of the conduit 3 is partially closed by the piston 4.

With particular reference to said moving means 5, said moving means 5 are connected to the piston 4 and move the piston 4 inside the conduit 3 in said first direction and in said second direction.

In the example that is described, said moving means 5 comprise a stepper motor.

Advantageously, by means of said stepper motor, the stroke of the piston 4 inside the conduit 3 is finely adjusted.

Furthermore, said moving means 5 are connected by means of a connection element 53 to the conduit 3.

In the example that is described, said connection element 53 is a ring nut.

Said moving means 5 are controlled by a control logic unit U described further below.

With particular reference to the supporting base 8, said supporting base 8 comprises a surface 8A and a cup holder 81, positioned on said surface 8A.

In particular, in the example that is described, the cup holder 81 is not coupled or constrained to the surface 8A and, therefore, it can be easily removed manually by an operator for the cleaning thereof.

Said cup holder 81 comprises a rest surface 81A on which the cup G is to be positioned.

The rest surface 81A of said cup holder 81 can be shaped and dimensioned based on the different types of cup G.

In the example that is described, the rest surface 81A of the cup holder 81 is (slightly) inclined with respect to the surface 8A of the supporting base 8, so that, when the cup G is positioned on the rest surface 81A, said cup G is inclined towards a wall 80A of the compartment 80.

It is preferable that said wall 80A be a bottom wall of the compartment 80.

However, it is not necessary for the rest surface 81A of the cup holder 81 to be inclined with respect to the surface 8A of the supporting base 8.

In fact, the rest surface 81A of the cup holder 81 can be parallel to the surface 8A of the supporting base 8, without going outside the scope of the invention.

In other words, the rest surface 81A lies in a first plane and the surface 8A lies in a second plane (parallel to a rest surface on which the dispensing device 1 is positioned) and said first plane forms with said second plane an angle that can be equal to 0° or an angle that can be greater than 0° and less than or equal to 5°.

In the example that is described, said angle is equal to 1.5°.

Advantageously, irrespective of the size of the cup G and in particular for cups of an average or reduced size, when the rest surface 81A is inclined with respect to the surface 8A, it reduces the possibility that any residues of slush present in the further conduit 6 (i.e. the conduit that connects the nozzle 7 to the conduit 3) at the end of the dispensing of the slush may fall outside the opening of the cup G.

Furthermore, said cup holder 81 comprises a raised part 81B (i.e. a part that extends upwards from a portion of said rest surface 81A).

The raised part 81B of the cup holder 81 can be provided with a cavity to facilitate the cleaning of said cup holder 81.

It is preferable that the surface 8A of said supporting base 8 be provided with one or more openings.

In particular, said surface 8A can be provided with a central opening, i.e. an opening positioned at the nozzle 7, and one or more further openings.

It is further preferable that the rest surface 81A also be provided with one or more further openings.

Moreover, the dispensing device 1 comprises a drawer 9, positioned between a base 10 and the surface 8A of the supporting base 8.

The drawer 9 can be extracted by an operator to remove the contents.

In the event that a quantity of slush comes out of the cup G accidentally and falls on the surface 8A of the supporting base 8 and/or on the rest surface 81A of the cup holder 81, that quantity of slush will fall (by gravity) into the drawer 9, through the openings of the surface 8A of the supporting base 8 and/or the openings of the rest surface 81A of the cup holder 81.

Furthermore, said dispensing device 1 further comprises:
at least one code reader CR for reading a QR code;
at least one presence sensor PS for detecting the presence of said cup G on said supporting base 8,
a weight sensor WS for detecting the weight of the cup G during the dispensing of the slush.

With particular reference to the code reader CR, said code reader CR is configured to acquire any information contained in a QR code.

In particular, the casing 11 comprises an external surface and the dispensing device 1 comprises at least one code reader CR arranged on said external surface.

In the example that is described, the dispensing device 1 comprises two code readers CR.

In particular, one code reader CR is arranged on a front wall of the casing 11 of the dispensing device 1 and a further code reader CR is arranged on a side wall of said casing 11.

In any case, it is sufficient that the dispensing device 1 be provided with at least one code reader CR.

As already mentioned, in the example that is described, said QR code is applied on the cup G.

After having taken the cup G, a user brings the cup G close to the code reader CR of the dispensing device 1 for the reading of the QR code and then positions the cup G on the supporting base 8 to receive the quantity of slush suitable for the capacity of the cup G.

With particular reference to the presence sensor PS, said presence sensor PS is configured to detect the presence of a cup G.

In the example that is described, said presence sensor PS is positioned on a wall 80A of said compartment 80.

In the example that is described, said dispensing device 1 comprises a plurality of presence sensors PS arranged on said wall 80A of said compartment 80 in such a way as to be aligned with each other.

In particular, said dispensing device 1 comprises three presence sensors PS arranged on a centre line of said wall 80A.

Each presence sensor PS is arranged at a respective height.

Advantageously, the fact that the dispensing device 1 is provided with a plurality of presence sensors PS (wherein the presence sensors PS are spaced apart and positioned at a respective height) allows for detecting not only the presence of the cup G on the supporting base 8, but also the height of the cup G and consequently the capacity thereof (for example, a small cup, medium cup, or large cup).

Each presence sensor PS is an optical sensor, i.e. a sensor configured to detect the presence of the cup G when the cup G is on a path of a light beam emitted by said optical sensor.

With particular reference to the weight sensor WS, said weight sensor WS is configured to detect the weight of said cup G.

In the example that is described, said weight sensor WS comprises a load cell.

In particular, in the example that is described, said cup holder 81 comprises a protruding part 81C that extends from the raised part 81B towards the outside and said weight sensor WS is connected to the cup holder 81 via a connection group 13 arranged in such a way that a first portion 131A of said connection group 13 contacts said protruding part 81C and a second portion 132A of said connection group 13 contacts a portion of said weight sensor WS, in such a way that, when a cup G is positioned on said cup holder 81, said second portion 132A exerts a pressure on said weight sensor WS.

The weight sensor WS is configured to convert a deformation value into a weight value.

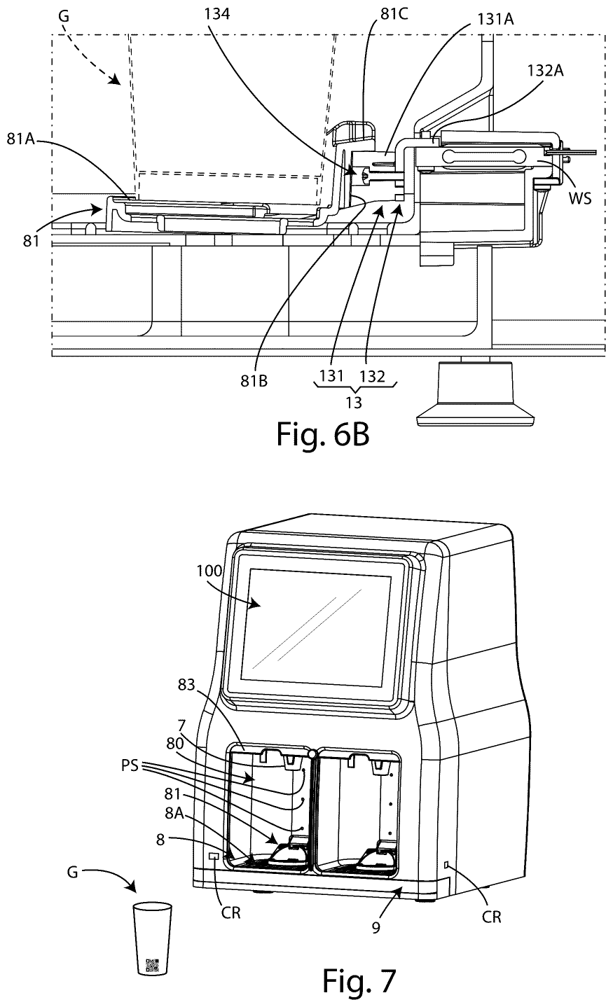

More in particular, said connection group 13 comprises (FIGS. 6A, 6B):
a first connection element 131 abutting with the raised part 81B of the cup holder 81 and comprising said first portion 131A in contact with said protruding part 81C, and
a second connection element 132 comprising said second portion 132A in contact with a portion of said weight sensor WS, wherein said first connection element 131 and said second connection element 132 are connected to each other.

In the example that is described, said first connection element 131 is connected to said second connection element 132 by means of a fastening element 134, such as, for example, a screw.

Furthermore, the first connection element 131 is connected to the second connection element 132 in such a way that the accidental rotation of said first connection element 131 with respect to said second connection element 132 is prevented.

To this end, said first connection element 131 is provided with at least one tooth (not shown) and said second connection element 132 is provided with a respective housing (not shown) for receiving said tooth.

Said tooth is coupled to said housing by means of a mating coupling.

In other words, the tooth is shaped so as to be inserted into said housing.

Furthermore, in the example that is described, the portion of the weight sensor WS in contact with the second portion 132A is a lateral portion.

When a cup G is positioned on the cup holder 81, the protruding part 81C of the cup holder 81 exerts a pressure on the first portion 131A of the first connection element 131, so that said first connection element 131 moves (slightly) and its movement causes a movement of the second connection element 132 and the latter exerts a pressure on the abovementioned portion of the weight sensor WS (i.e. the portion in contact with the second portion 132A of the second connection element 132) in such a way that the weight sensor WS (i.e. the load) undergoes a (slight) deformation.

The value of said deformation is converted into a weight value referring to the cup G.

In other words, the pressure exerted by the protruding part 81C of the cup holder 81 on said first connection element 131 is transferred onto the second connection element 132, which exerts a pressure on a portion of said weight sensor WS in contact with the second portion 132A of the second connection element 132.

Furthermore, said dispensing device 1 comprises:
storage means SM in which the following data are stored:
   one or more predetermined slushes,
   one or more predetermined capacities of a cup G,
   a predetermined weight associated with a respective slush to be dispensed into said cup G and a respective predetermined capacity of said cup G,
a control logic unit U configured to:
   acquire, through said presence sensor PS, information concerning the presence of the cup G on the supporting base 8,
   acquire, through said code reader CR, information contained in the QR code concerning the capacity of the cup G,
   acquire, through said weight sensor WS, the weight of the cup G over time during the dispensing of the slush,
   send a signal to said moving means 5 for moving said piston 4 in such a way that said piston 4 approaches the opening 3A of the conduit 3 until partially or totally covering said opening 3A, so as to reduce the quantity of slush to be dispensed or terminate the dispensing of said slush, or that said piston 4 moves away from the opening 3A of the conduit 3, so as to increase the quantity of slush to be dispensed, based on the weight of the cup G acquired over time during the dispensing of the slush with respect to a predetermined slush and to a predetermined weight associated with a predetermined capacity, wherein said predetermined slush is equal to the slush dispensed by said dispensing device 1 and said predetermined capacity is equal to the acquired capacity.

In other words, the control logic unit U acquires the capacity of the cup G (via the reading of the QR code) and the weight of the cup G over time, during the dispensing of the slush, and compares the acquired weight with a predetermined weight (stored in said storage means SM) associated with a predetermined capacity which corresponds to the capacity of the cup G into which the slush is dispensed.

Consequently, the control logic unit U sends a signal to said moving means 5 for moving the piston 4 inside the conduit 3 in such a way as to reduce or increase the quantity of slush to be dispensed based on a difference (i.e. a difference in weight) between the weight of the cup G acquired over time (due to the quantity of slush that is received over time by the cup G) and a predetermined weight, or in such a way as to stop the dispensing, when said difference is zero.

As the predetermined weight stored in said storage means SM is associated with a predetermined capacity, the control logic unit U is configured to select the predetermined weight which is associated with a predetermined capacity that is equal to the capacity of the cup G to be filled with the slush.

With reference to said storage means SM, said storage means SM comprise a memory.

In the example that is described, said storage means SM are external to the control logic unit U.

However, said storage means SM can be included in said control logic unit U, without going outside the scope of the invention.

With reference to the QR code, it is preferable that said QR code also contain information concerning a unique identification code associated with the cup G to enable an operator to verify how many cups have been used.

The control logic unit U can be configured to acquire the unique identification code associated with each cup G (which is filled with slush) and count the unique identification codes acquired to determine a total number of cups G (filled with slush).

Furthermore, in said storage means SM a plurality of predetermined unique identification codes can be stored, each of which is associated with a respective cup G and the control logic unit U can be configured to:
verify whether the unique identification code associated with a cup G, acquired via the code reader CR, corresponds to one of said predetermined unique identification codes, and
if said unique identification code corresponds to one of said predetermined unique identification codes, prevent the dispensing of a slush into said cup G.

Advantageously, this verification prevents the same cup G from being filled twice.

It is preferable that the control logic unit U be configured to store information concerning the fact that the cup G associated with said unique identification code has already been filled with a slush.

In the embodiment that is described, the dispensing device 1 comprises:
at least one compartment 80 provided with an opening for inserting said cup G, wherein said compartment 80 comprises said supporting base 8,
a respective door 83 for closing the opening of said compartment 80.

Said door 83 comprises at least one portion made of transparent material.

Advantageously, the fact that the door 83 comprises at least one portion made of transparent material allows a user to verify that the dispensing has terminated.

In the example that is described, said door 83 is totally transparent.

In the embodiment that is described, the opening/closing of said door 83 is manual.

In particular, the door 83 is raised to access the compartment 80 and lowered to close the opening of said compartment 80.

The dispensing device 1 has an internal cavity for receiving at least a part of said door 83.

However, the door 83 can be rotatably connected to an end portion of said compartment 80 in order to rotate about a rotation axis (perpendicular to the supporting base 8), without going outside the scope of the invention.

In this case, it will be sufficient to rotate said door 83 in a first direction to access the compartment 80 and in a second direction (opposite to said first direction) to close the opening of said compartment 80.

In an alternative, not shown in the Figures, the opening and closing of said door 83 can be motorised.

In said alternative, said dispensing device 1 can comprise opening/closing means to open/close said door 83 and a motor connected to said opening/closing means, and the control logic unit U can be configured to send a signal to said motor to open said door 83, when it is necessary to position a cup G on the supporting base 8 (i.e. on the cup holder 81) and send a further signal to said motor to close said door 83, when the cup G is positioned on the supporting base 8.

In particular, it is preferable that said control logic unit U be configured to send a signal to said moving means 5 for moving said piston 4 so that said piston 4 closes the opening 3A of the conduit 3, when said door 83 is open during the dispensing of said slush, so as to stop the dispensing of said slush.

In this manner, the dispensing of the slush is stopped when the door 83 is opened, so as to prevent the slush from being dispensed when the door 83 is open.

In this manner, if a user opens the door 83 to take the cup G during the dispensing of the slush, the dispensing of the slush will be stopped.

The dispensing device 1 further comprises a user interface module 100.

Said user interface module 100 can be configured to display information relating to one or more beverages/slushes contained in a respective receptacle or tank 2 or to enable a user to give a command to the dispensing device 1.

In the example that is described, said user interface module 100 comprises a display.

In a variant, not shown in the Figures, the weight sensor WS can coincide with the presence sensor PS.

In this case, the weight sensor WS is configured to detect the presence of the cup G through the weight of the cup G itself.

In other words, the dispensing device 1 can have a sole sensor between the presence sensor PS and the weight sensor WS.

In said variant, the dispensing device 1 comprises a weight sensor WS by means of which it is possible to detect both the presence of the cup G (due to the weight of the cup G) and the weight of the cup G.

Advantageously, in said variant, the dispensing device 1 has a simplified structure, as the number of components is reduced, due to the presence of a sole sensor, i.e. the weight sensor WS.

In said variant, the dispensing device 1 differs from the dispensing device described above in that it is lacking one or more presence sensors.

In an alternative, said weight sensor WS can be positioned below the cup holder 81, at a central opening of said cup holder 81 (i.e. an opening at the nozzle 7).

In said alternative, the load cell of the weight sensor WS deforms in a central portion.

FIGS. 7 to 10 show an application of the dispensing device 1 for dispensing a slush.

FIG. 7 shows the dispensing device 1 and a cup G in proximity to the dispensing device 1 so that the QR code applied on the cup G is read by the code reader CR of the dispensing device 1.

After the reading of the QR code, the cup G can be positioned on the supporting base 8 (and in particular on the cup holder 81) of the dispensing device 1 (inside the compartment 80) to receive the slush.

The control logic unit U (connected to the code reader CR) acquires information contained in the QR code.

In particular, the control logic unit U acquires the information concerning the capacity of the cup G.

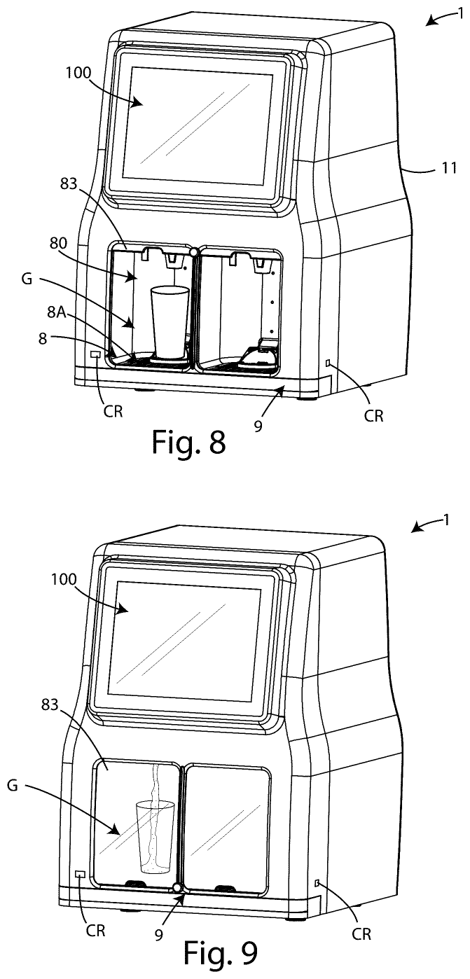

FIG. 8 shows the dispensing device 1 when the cup G has been positioned on the cup holder 81 so as to be filled with slush.

FIG. 9 shows the dispensing device 1 in use.

The quantity of slush dispensed by the dispensing device 1 fills the cup G over time.

As is known and already mentioned, the slush can have a density which changes over time based on different factors, such as, for example, the quantity of sugar, the temperature, how long the slush remained in the receptacle 2 before being dispensed, the quantity of slush present in the receptacle 2, the pushing force exerted by pushing means to push a quantity of slush into the conduit 3 (wherein said pushing means comprise a feed screw arranged inside a receptacle 2).

The higher the density of the slush, the more time will be necessary to fill the cup G.

In this first case, the control logic unit U sends a signal to said moving means 5 so that the piston 4 closes the opening 3A of the conduit 3 after a first time interval since the start of the dispensing.

The lower the density of the slush, the less time will be necessary to fill the cup G.

In this second case, the control logic unit U sends a signal to said moving means 5 so that the piston 4 closes the opening 3A of the conduit 3 after a second time interval since the start of the dispensing, shorter than the first time interval mentioned above.

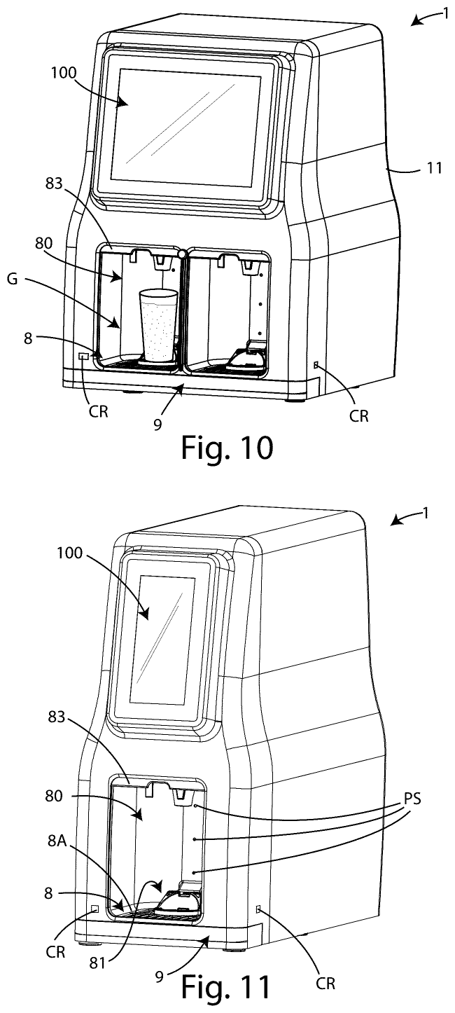

FIG. 10 shows the dispensing device 1 when the dispensing has terminated and the cup G is filled with slush.

In particular, the door 83 is open to enable a user to take the cup G.

The above-described dispensing device 1 has two compartments for the insertion of a respective cup G.

However, as already mentioned, the dispensing device 1 can comprise any number of compartments, even a single compartment 80.

A dispensing device 1 comprising a single compartment 80 is shown in FIG. 11.

The present invention also relates to a dispensing method for dispensing a slush through a dispensing device 1 as mentioned above.

Said method comprising the following steps:
A) reading a QR code,
B) acquiring information contained in the QR code concerning the capacity of the cup G,
C) positioning a cup G on the supporting base 8,
D) acquiring information concerning the presence of the cup G on the supporting base 8,
E) acquiring the weight of the cup G over time during the dispensing of the slush,
F) sending a signal to said moving means 5 for moving said piston 4 in such a way that said piston 4 approaches said opening 3A until partially or totally covering said opening 3A, so as to reduce the quantity of slush to be dispensed or terminate the dispensing of said slush, or that said piston 4 moves away from said opening 3A, so as to increase the quantity of slush to be dispensed, based on the weight of the cup G acquired over time, during the dispensing of the slush, with respect to a predetermined slush and to a predetermined weight associated with a predetermined capacity, said predetermined slush being equal to the slush dispensed by said dispensing device 1 and said predetermined capacity being equal to the acquired capacity.

Advantageously, the dispensing device of the invention makes it possible to automatically dose the quantity of beverage/slush to be poured into a cup.

The present invention has been described by way of illustration and not by way of limitation, according to a preferred embodiment thereof, but it is to be understood that variations and/or modifications can be introduced by the person skilled in the art without going outside the relevant scope of protection, as defined by the appended claims.

1. A dispending device for dispensing a beverage/slush, the dispensing device comprising:
a receptacle containing a beverage/slush;
a conduit connected to said receptacle for receiving said beverage/slush and provided with an opening,
a piston movable in said conduit in a first direction and in a second direction, opposite to said first direction, so that said opening is closed or free or partially closed according to the movement of said piston in said conduit,
moving means for moving said piston in said conduit,
a supporting base for supporting a cup,
at least one code reader for reading a QR code;
at least one presence sensor for detecting the presence of a cup on said supporting base,
at least one weight sensor for detecting the weight of the cup over time during dispensing of the beverage/slush;
storage means in which the following data are stored:
one or more predetermined beverages/slushes,
one or more predetermined capacities of a cup,
a predetermined weight associated with a respective beverage/slush to be dispensed into said cup and a respective predetermined capacity of said cup,
a control logic unit configured to:
acquire, through the presence sensor, information concerning the presence of the cup on the supporting base,
acquire, through the code reader, information contained in the QR code concerning the capacity of the cup,
acquire, through said weight sensor, the weight of the cup over time during dispensing of the beverage/slush,
send a signal to said moving means to move said piston so that said piston approaches said opening until said piston partially or totally covers said opening, so as to reduce the quantity of beverage/slush to be dispensed or terminate the dispensing of said beverage/slush, or that said piston moves away from said opening, so as to increase the quantity of beverage/slush to be dispensed, based on the weight of the cup acquired over time, during the dispensing of the beverage/slush, with respect to a predetermined beverage/slush and to a predetermined weight associated with a predetermined capacity, said predetermined beverage/slush being equal to the beverage/slush dispensed by said dispensing device and said predetermined capacity being equal to the acquired capacity.

2. The dispensing device according to the previous claim 1, further comprising a compartment for receiving said cup, wherein said compartment comprises an opening and said supporting base.

3. The dispensing device according to claim 2, wherein said at least one presence sensor is arranged on a wall of said compartment.

4. The dispensing device according to claim 3, further comprising a plurality of presence sensors, wherein the presence sensors of said plurality of presence sensors are arranged on said wall of said compartment in such a way as to be aligned; each presence sensor being arranged at a respective height.

5. The dispensing device according to claim 1, wherein said at least one presence sensor is an optical sensor.

6. The dispensing device (1) according to claim 1, wherein
said supporting base comprises a cup holder, wherein
said cup holder comprises a supporting surface, a raised part which extends from a portion of said supporting surface, and a protruding part extending from said raised part towards the outside,
wherein
said weight sensor is connected to said cup holder via a connection group arranged in such a way that a first portion of said connection group contacts said protruding part and a second portion of said connection group contacts a portion of said weight sensor, in such a way that, when a cup is positioned on said cup holder, said second portion exerts a pressure on said weight sensor.

7. The dispensing device according to claim 1, wherein said weigh sensor coincides with said presence sensor.

8. The dispensing device according to claim 1, wherein said weight sensor comprises a load cell.

9. The dispensing device according to claim 1, further comprising:
a casing, wherein said casing comprises an external surface and said code reader is arranged on said external surface.

10. The dispensing device according to claim 1, further comprising:
a door for closing said opening of said compartment, and
opening/closing means for opening/closing said door.

11. The dispensing device according to claim 10, further comprising:
a motor connected to said opening/closing means to open/close said door , and
said control logic unit is configured to:
send a signal to said motor to open said door, when said cup is to be positioned on said supporting base, and
send a further signal to close said door, when said cup is positioned on said supporting base.

12. The dispensing device according to claim 11, wherein said logic control unit is configured to send a signal to said moving means for moving said piston in such a way that said piston closes the opening of said conduit when said door is opened during the dispensing of said beverage/slush, so as to stop the dispensing of said beverage/slush.

13. A dispensing system comprising a dispensing device according to claim 1 and a cup, wherein said cup is provided with a QR code.

14. A method for dispensing a beverage/slush through a dispensing device according to claim 1, the method comprising the following steps:
A) reading a QR code,
B) acquiring information contained in the QR code concerning the capacity of the cup,
C) positioning a cup on the supporting base,
D) acquiring information concerning the presence of the cup on the supporting base,
E) acquiring the weight of the cup over time during the dispensing of the beverage/slush,
F) sending a signal to said moving means for moving said piston so that said piston approaches said opening until said piston partially or totally covers said opening, so as to reduce the quantity of beverage/slush to be dispensed or terminate the dispensing of said beverage/slush, or that said piston moves away from said opening, so as to increase the quantity of beverage/slush to be dispensed, based on the weight of the cup acquired over time, during the dispensing of the beverage/slush, with respect to a predetermined beverage/slush and to a predetermined weight associated with a predetermined capacity, said predetermined beverage/slush being equal to the beverage/slush dispensed by said dispensing device and said predetermined capacity being equal to the acquired capacity.
